(19) United States
(12) Patent Application Publication
(10) Pub. No.: US 2009/0193363 A1
(43) Pub. Date: Jul. 30, 2009

(54) Representing Multiple Computing Resources Within A Predefined Region Of A Graphical User Interface For Displaying A Single Icon

(75) Inventor: William E. Atherton, Hillsborough, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 12/022,922

(22) Filed: Jan. 30, 2008

(51) Int. Cl. G06F 3/048

(52) U.S. Cl. 715/835

(57) ABSTRACT

Methods, apparatus, and products are disclosed for representing multiple computing resources within a predefined region of a graphical user interface (‘GUI’) for displaying a single icon that include: identifying a plurality of computing resources for representation on the GUI in a predefined region for displaying a single icon, each computing resource associated with a portion of the predefined region; rendering a display icon in the predefined region; identifying a location of an input device pointer within the predefined region; and activating the computing resource associated with the portion of the predefined region in which the input device pointer is located when a user operates the display icon.

### BACKGROUND OF THE INVENTION

1. Field of the Invention

The field of the invention is data processing, or, more specifically, methods, apparatus, and products for representing multiple computing resources within a predefined region of a graphical user interface (‘GUI’) for displaying a single icon.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

To aid users in utilizing such power computing systems, these systems often employ the use of complex graphical user interfaces (‘GUIs’). These GUIs assist users in locating and using computing resources by visually representing each computing resources to a user as an icon or graphic. When a user operates an icon on a GUI, the computing system renders or executes the computing resource represented by that icon. The drawback to current use of icons to represent computing resources, however, is that the current usage often contributes to excess clutter on the GUI. As more and more computing resources are represented on the GUI through individual icons, the GUI becomes filled with icons. Displaying large numbers of icons on a GUI at any given time often confuses users and thwarts the goal of a GUI to assist users in locating and using computing resources.

### SUMMARY OF THE INVENTION

Methods, apparatus, and products are disclosed for representing multiple computing resources within a predefined region of a graphical user interface for displaying a single icon that include: identifying a plurality of computing resources for representation on the GUI in a predefined region for displaying a single icon, each computing resource associated with a portion of the predefined region; rendering a display icon in the predefined region; identifying a location of an input device pointer within the predefined region; and activating the computing resource associated with the portion of the predefined region in which the input device pointer is located when a user operates the display icon.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computing system useful in representing multiple computing resources within a predefined region of a graphical user interface for displaying a single icon according to embodiments of the present invention.

FIG. 2 sets forth a flow chart illustrating an exemplary method for representing multiple computing resources within a predefined region of a graphical user interface for displaying a single icon according to embodiments of the present invention.

FIG. 3 sets forth a flow chart illustrating a further exemplary method for representing multiple computing resources within a predefined region of a graphical user interface for displaying a single icon according to embodiments of the present invention.

FIG. 4A sets forth line drawing of an exemplary GUI useful in representing multiple computing resources within a predefined region of a graphical user interface for displaying a single icon according to embodiments of the present invention.

FIG. 4B sets forth line drawing of an exemplary GUI useful in representing multiple computing resources within a predefined region of a graphical user interface for displaying a single icon according to embodiments of the present invention.

FIG. 4C sets forth line drawing of an exemplary GUI useful in representing multiple computing resources within a predefined region of a graphical user interface for displaying a single icon according to embodiments of the present invention.

FIG. 4D sets forth line drawing of an exemplary GUI useful in representing multiple computing resources within a predefined region of a graphical user interface for displaying a single icon according to embodiments of the present invention.

FIG. 5 sets forth a flow chart illustrating a further exemplary method for representing multiple computing resources within a predefined region of a graphical user interface for displaying a single icon according to embodiments of the present invention.

FIG. 6 sets forth a flow chart illustrating a further exemplary method for representing multiple computing resources within a predefined region of a graphical user interface for displaying a single icon according to embodiments of the present invention.

### DETAILED DESCRIPTION OF EXEMPLARY EMBODIMENTS

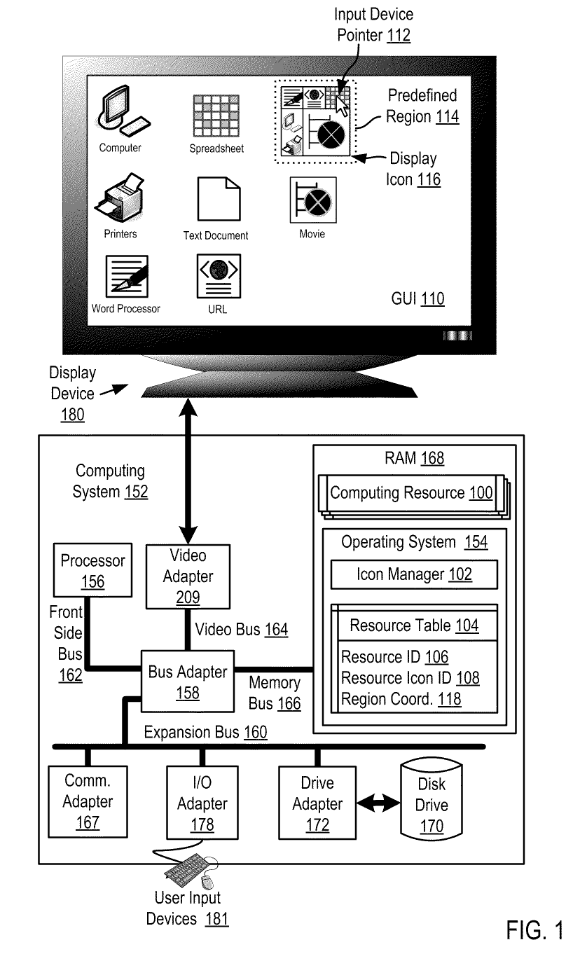

Exemplary methods, apparatus, and products for representing multiple computing resources within a predefined region of a graphical user interface (‘GUI’) for displaying a single icon in accordance with the present invention are described with reference to the accompanying drawings, beginning with FIG. 1. Representing multiple computing resources within a predefined region of a graphical user interface (‘GUI’) for displaying a single icon in accordance with the present invention is generally implemented with computers, that is, with automated computing machinery. For further explanation, therefore, FIG. 1 sets forth a block diagram of automated computing machinery comprising an exemplary computing system (152) useful in representing multiple computing resources within a predefined region of a graphical user interface (‘GUI’) for displaying a single icon according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152). Stored in RAM (168) is an operating system (154). Operating systems useful representing multiple computing resources within a predefined region of a graphical user interface (‘GUI’) for displaying a single icon according to embodiments of the present invention include UNIX™, Linux™, Microsoft XP™, AIX™, IBM's i5/OS™, and others as will occur to those of skill in the art.

In the exemplary system of FIG. 1, the operating system (154) includes an icon manager (102). The icon manager (102) of FIG. 1 is a set of computer program instructions for representing multiple computing resources within a predefined region (114) of a GUI for displaying a single icon according to embodiments of the present invention. A computing resource is any aggregation of data or computer program instructions for data processing. Examples of computing resources may include word processing documents, spreadsheets, databases, web pages, executable programs, scripts, object shortcuts, file systems, or any other computing resource as will occur to those of skill in the art. Computing resources may be implemented using binary machine code, eXtensible Markup Language (‘XML’) documents, C++ objects, Java objects, Uniform Resource Locators (‘URLs’), JavaScript™, or any other format as will occur to those of ordinary skill in the art.

In the example of FIG. 1, the icon manager (102) operates generally for representing multiple computing resources within a predefined region of a GUI for displaying a single icon according to embodiments of the present invention by: identifying a plurality of computing resources (100) for representation on the GUI (110) in a predefined region (114) for displaying a single icon, each computing resource (100) associated with a portion of the predefined region (114); rendering a display icon (116) in the predefined region (114); identifying a location of an input device pointer (112) within the predefined region (114); and activating the computing resource (100) associated with the portion of the predefined region (114) in which the input device pointer (112) is located when a user operates the display icon (116). In the example of FIG. 1, the predefined region (114) is represented on the GUI (110) as a dotted box and is the size of a region on a GUI for displaying a single icon. Readers will note that although only one predefined region for displaying a single icon is depicted in FIG. 1, other predefined regions exist for the other seven icons rendered on the GUI (110) in FIG. 1.

In the exemplary system of FIG. 1, each portion of the predefined region (114) is associated with a computing resource (100) using a resource table (104). Each record in the resource table (104) includes a resource identifier field (106), a resource icon identifier field (108), and a region coordinates field (118). The resource identifier field (106) specifies a particular computing resource (100). The resource icon identifier field (108) specifies an icon or graphic that may be issued to represent the associated computing resource. The region coordinates field (118) specifies the portion of the predefined region (114) that is assigned to the associated computing resource. Consider, for example, the predefined region (114) in illustrated in FIG. 1. The predefined region in FIG. 1 may be represented by the following exemplary resource table:

TABLE 1
EXEMPLARY RESOURCE TABLE

| RESOURCE ID | RESOURCE ICON ID | REGION COORDINATES |
|---|---|---|
| Word_Processor | Word_Processor_Icon | (0, 0) → (10, 10) |
| Web_Page | Web_Page_Icon | (10, 0) → (20, 10) |
| Spreadsheet | Spreadsheet_Icon | (20, 0) → (30, 10) |
| File_Manager | File_Manager_Icon | (0, 10) → (10, 20) |
| Printer_Manager | Printer_Manager_Icon | (0, 20) → (10, 30) |
| Movie | Movie_Icon | (10, 10) → (30, 30) |

The exemplary resource table above associates a computing resource implemented as a word processor with the upper left portion of the predefined region (114), specifically a square region having opposite corners at pixel coordinates (0,0) and (10,10) relative to the upper left corner of the predefined region (114). The exemplary resource table associates a computing resource implemented as a web page with the upper middle portion of the predefined region (114), specifically a square region having opposite corners at pixel coordinates (10,0) and (20,10) relative to the upper left corner of the predefined region (114). The exemplary resource table associates a computing resource implemented as a spreadsheet with the upper right portion of the predefined region (114), specifically a square region having opposite corners at pixel coordinates (20,0) and (30,10) relative to the upper left corner of the predefined region (114). The exemplary resource table associates a computing resource implemented as a file manager with the middle left portion of the predefined region (114), specifically a square region having opposite corners at pixel coordinates (0,10) and (10,20) relative to the upper left corner of the predefined region (114). The exemplary resource table associates a computing resource implemented as a printer manager with the lower left portion of the predefined region (114), specifically a square region having opposite corners at pixel coordinates (0,20) and (10,30) relative to the upper left corner of the predefined region (114). The exemplary resource table associates a computing resource implemented as a movie with the lower right portion of the predefined region (114), specifically a square region having opposite corners at pixel coordinates (10,10) and (30,30) relative to the upper left corner of the predefined region (114). Readers will note that the exemplary resource table above and the predefined region illustrated in FIG. 1 is for explanation only and not for limitation.

To help the user identify which portions of the predefined region (114) are associated with the various computing resources (100) in the example of FIG. 1, the display icon (116) rendered in the predefined region (114) constitutes a composite of the various resource icons for each of the computing resources (100). A resource icon is an icon associated with a particular computing resource such as, for example, an icon of a software program predesignated by the program's developer. A resource icon differs from the display icon in that the display icon rendered in a predefined region for a single icon may be implemented as a resource icon, a composite of multiple resource icons, or some other graphic not actually associated with any computing resource. Readers will note therefore that the exemplary display icon (116) of FIG. 1 is for illustration only and not for limitation. While the display icon (116) illustrated in FIG. 1 constitutes a composite of the various resource icons for each of the computing resources (100), such a display icon may be implemented entirely as a single resource icon for the computing resource associated with the portion of the predefined region (114) over which the input device pointer (112) is located. In such a manner, the display icon (116) changes as the input device pointer (112) moves within the predefined region (114). Still further, readers will note that the display icon may not even be implemented using any of the resource icons for the computing resources associated with various portions of the predefined region (114). In such a case, a display icon may merely serve to provide the user with a visual reference point for the location of the predefined region (114) on the GUI (110).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for representing multiple computing resources within a predefined region of a graphical user interface (‘GUI’) for displaying a single icon according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art. Readers will note that although the operating system (154), including the icon manager (102) and the resource table (104), and the computing resources (100) in the example of FIG. 1 are shown in RAM (168), many components of such software typically are stored in non-volatile memory also, such as, for example, on a disk drive (170).

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers and for data communications with a data communications network. Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for representing multiple computing resources within a predefined region of a graphical user interface (‘GUI’) for displaying a single icon according to embodiments of the present invention include modems for wired dial-up communications, Ethernet (IEEE 802.3) adapters for wired data communications network communications, and 802.11 adapters for wireless data communications network communications.

Readers will note that the exemplary computer architecture illustrated in FIG. 1 is for explanation only and not for limitation. Other computer architectures as will occur to those of ordinary skill in the art may also be useful for representing multiple computing resources within a predefined region of a graphical user interface for displaying a single icon according to embodiments of the present invention.

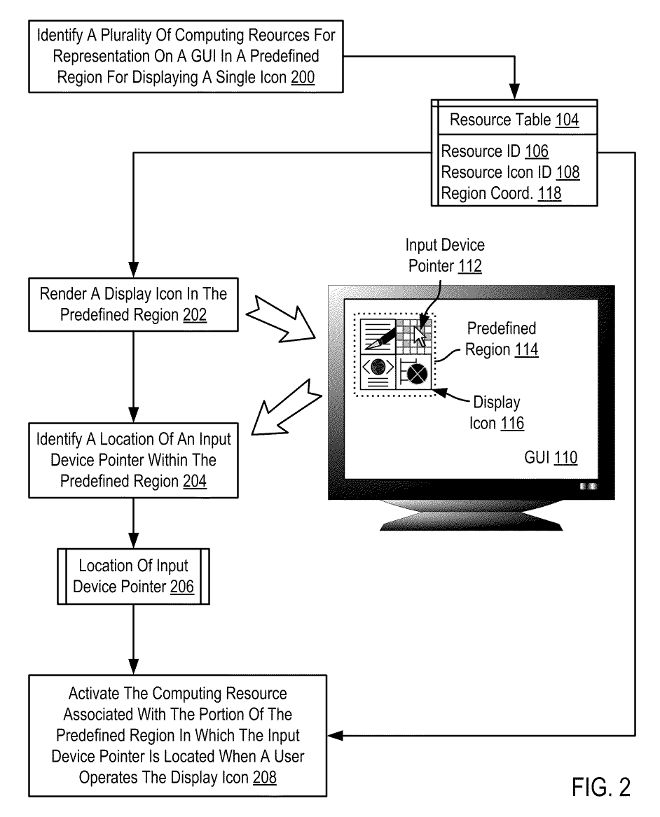

For further explanation, FIG. 2 sets forth a flow chart illustrating an exemplary method for representing multiple computing resources within a predefined region of a graphical user interface for displaying a single icon according to embodiments of the present invention. The method of FIG. 2 includes identifying (200) a plurality of computing resources for representation on a GUI in a predefined region (114) for displaying a single icon. Identifying (200) a plurality of computing resources for representation on a GUI in a predefined region (114) for displaying a single icon according to the method of FIG. 2 may be carried out by identifying the computing resources specified by the records in the resource table (104) for the predefined region (114).

Each computing resource is associated with a portion of the predefined region (114) in the example of FIG. 2 using a resource table (104) for the predefined region (114). Each record in the resource table (104) of FIG. 2 includes a resource identifier field (106), a resource icon identifier field (108), and a region coordinates field (118). The resource identifier field (106) specifies a particular computing resource (100). The resource icon identifier field (108) specifies an icon or graphic that may be issued to represent the associated computing resource. The region coordinates field (118) specifies the portion of the predefined region (114) that is assigned to the associated computing resource. Consider, for example, the predefined region (114) in illustrated in FIG. 2. The predefined region (114) in FIG. 2 may be represented by the following exemplary resource table:

TABLE 2
EXEMPLARY RESOURCE TABLE

| RESOURCE ID | RESOURCE ICON ID | REGION COORDINATES |
|---|---|---|
| Word_Processor | Word_Processor_Icon | (0, 0) → (15, 15) |
| Web_Page | Web_Page_Icon | (0, 15) → (15, 30) |
| Spreadsheet | Spreadsheet_Icon | (15, 0) → (30, 15) |
| Movie | Movie_Icon | (15, 15) → (30, 30) |

The exemplary resource table above associates a computing resource implemented as a word processor with the upper left portion of the predefined region (114), specifically a square region having opposite corners at pixel coordinates (0,0) and (15,15) relative to the upper left corner of the predefined region (114). The exemplary resource table associates a computing resource implemented as a web page with the lower left portion of the predefined region (114), specifically a square region having opposite corners at pixel coordinates (0,15) and (15,30) relative to the upper left corner of the predefined region (114). The exemplary resource table associates a computing resource implemented as a spreadsheet with the upper right portion of the predefined region (114), specifically a square region having opposite corners at pixel coordinates (15,0) and (30,15) relative to the upper left corner of the predefined region (114). The exemplary resource table associates a computing resource implemented as a movie with the lower right portion of the predefined region (114), specifically a square region having opposite corners at pixel coordinates (15,15) and (30,30) relative to the upper left corner of the predefined region (114). Readers will note that the exemplary resource table above and the predefined region illustrated in FIG. 1 is for explanation only and not for limitation.

The method of FIG. 2 also includes rendering (202) a display icon (116) in the predefined region (114). Rendering (202) a display icon (116) in the predefined region (114) according to the method of FIG. 2 may be carried out by generating a display icon (116) in dependence upon the resource icon for each of the computing resources associated with the predefined region (114). Consider, for example, the previous exemplary resource table above. Generating a display icon (116) in dependence upon the resource icon for each of the computing resources associated with the predefined region (114) may be carried out by aggregating miniature versions of the resource icons specified in the resource table (104) for each computing resource into a single display icon (116) such that the size of each miniature resource icon matches the region coordinates associated with each resource icon in the resource table (104). As mentioned above, however, implementing the display icon as a composite of multiple resource icons is for explanation only and not for limitation.

The method of FIG. 2 includes identifying (204) a location of an input device pointer (112) within the predefined region (114). Identifying (204) a location of an input device pointer (112) within the predefined region (114) according to the method of FIG. 2 may be carried out by receiving a location notification message from the GUI subsystem in the operating system that specifies the location of the input device pointer (112) on the GUI (110). The GUI subsystem typically sends such location notification messages as the user moves the user input pointer around the GUI.

The method of FIG. 2 includes activating (208) the computing resource associated with the portion of the predefined region (114) in which the input device pointer (112) is located when a user operates the display icon (116). Activating (208) the computing resource associated with the portion of the predefined region (114) in which the input device pointer (112) is located when a user operates the display icon (116) according to the method of FIG. 2 may be carried out by receiving a user operation notification message from the GUI subsystem in the operating system that the user operated the display icon (116), determining from the resource table (104) which computing resource is associated with the portion of the predefined region (114) in which the input device pointer (112) is located when the user operated the display icon (116), and invoking an operating system function to activate that computing resource. In such a manner, as the user operates different parts of the display icon (116) of FIG. 2, different computing resources are activated. Readers will note that although the location notification message mentioned above and the user operation notification message are implemented using two separate messages from the GUI subsystem, in other embodiments the two messages may be implemented using a single message.

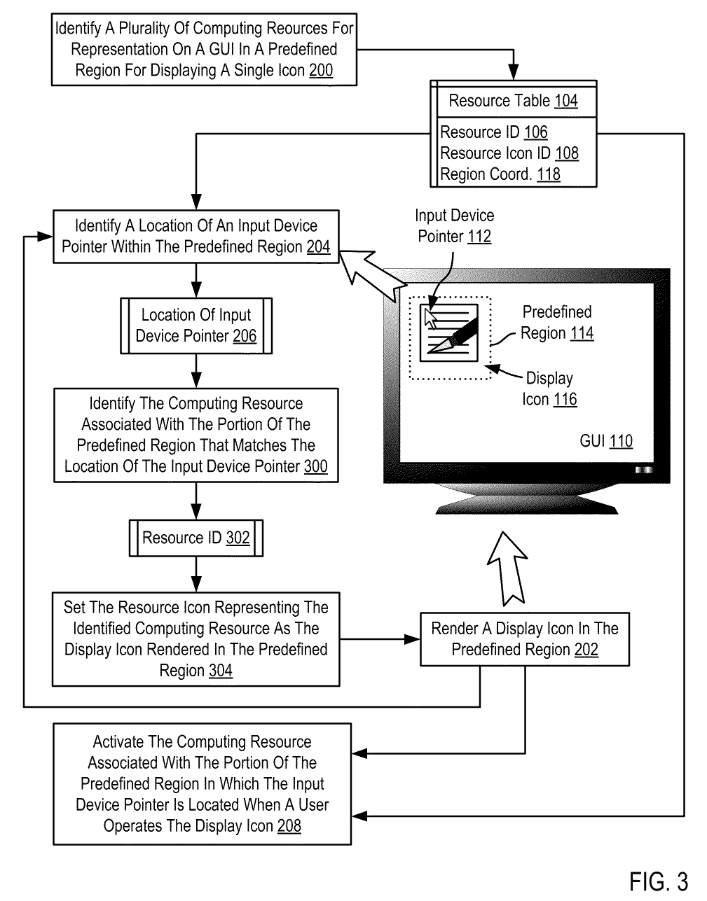

In the example of FIG. 2, the display icon rendered in the predefined region is implemented as a composite from multiple resource icons for the computing resources associated with the predefined region. In such manner, the display icon does not change as the input device pointer moves from one portion of the predefined region to another. In some embodiments, however, the display icon does change as the input device pointer moves from one portion of the predefined region to another. For further explanation, therefore, FIG. 3 sets forth a flow chart illustrating a further exemplary method for representing multiple computing resources within a predefined region of a graphical user interface (‘GUI’) for displaying a single icon according to embodiments of the present invention.

The method of FIG. 3 includes identifying (200) a plurality of computing resources for representation on a GUI in a predefined region (114) for displaying a single icon. Identifying (200) a plurality of computing resources for representation on a GUI (110) in a predefined region (114) for displaying a single icon according to the method of FIG. 3 may be carried out as described above with reference to FIG. 2. Each computing resource is associated with a portion of the predefined region (114) using a resource table (104) of FIG. 3. Each record in the resource table (104) of FIG. 3 includes a resource identifier field (106), a resource icon identifier field (108), and a region coordinates field (118). The resource identifier field (106) specifies a particular computing resource (100). The resource icon identifier field (108) specifies an icon or graphic that may be issued to represent the associated computing resource. The region coordinates field (118) specifies the portion of the predefined region (114) that is assigned to the associated computing resource.

The method of FIG. 3 also includes identifying (204) a location (206) of an input device pointer (112) within the predefined region (114). Identifying (204) a location of an input device pointer (112) within the predefined region (114) according to the method of FIG. 3 may be carried out by receiving a location notification message from the GUI subsystem in the operating system that specifies the location of the input device pointer (112) on the GUI (110).

The method of FIG. 3 includes identifying (204) the computing resource associated with the portion of the predefined region (114) that matches the location of the input device pointer (112). As mentioned above, the resource table (104) associates different computing resources with different portions of the predefined region (114). Identifying (204) the computing resource associated with the portion of the predefined region (114) that matches the location of the input device pointer (112) according to the method of FIG. 3 may therefore be carried out by determining from the resource table (104) which resource identifier (302) is associated with the portion of the predefined region (114) in which the input device pointer (112) is located.

The method of FIG. 3 also includes setting (304) the resource icon representing the identified computing resource as the display icon (116) rendered in the predefined region (114). Setting (304) the resource icon representing the identified computing resource as the display icon (116) rendered in the predefined region (114) according to the method of FIG. 3 may be carried out by selecting the resource icon specified by the resource icon identifier associated with the resource identifier (302) in the resource table (104).

The method of FIG. 3 includes rendering (202) a display icon (116) in the predefined region (114). Rendering (202) a display icon (116) in the predefined region (114) according to the method of FIG. 3 may be carried out by displaying the display icon (116) in the predefined region until the input device pointer (112) moves to a location within another portion of the predefined region (114). In such a manner, as the user moves the input device pointer (112) to different portions of the predefined region (114) on the GUI (110), different icons are displayed to represent the different computing resources accessible within the predefined region (114) for displaying a single icon.

The method of FIG. 3 includes activating (208) the computing resource associated with the portion of the predefined region (114) in which the input device pointer (112) is located when a user operates the display icon (116). Activating (208) the computing resource associated with the portion of the predefined region (114) in which the input device pointer (112) is located when a user operates the display icon (116) according to the method of FIG. 3 may be carried out by invoking an operating system function to activate that computing resource specified by the resource identifier (302).

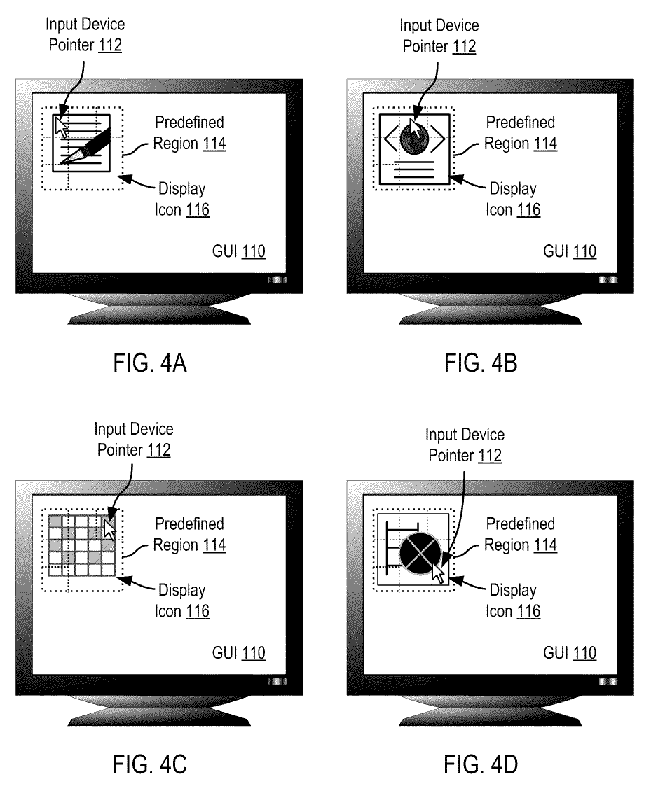

To illustrate how the display icon changes as the input device pointer moves around the predefined region, consider FIGS. 4A-D that set forth line drawings of exemplary GUIs useful in representing multiple computing resources within a predefined region of a graphical user interface (‘GUI’) for displaying a single icon according to embodiments of the present invention. Each GUI (110) in the examples of FIGS. 4A-D illustrate the display icon (116) rendered in the predefined region (114) when the input device pointer (112) is in different locations within the predefined region (114).

In the example of FIG. 4A, the input device pointer (112) is located in the upper left portion of the predefined region (114). In the example of FIG. 4A, a computing system identifies that a computing resource implemented as a word processing program is associated with the portion of the predefined region (114) that matches the location of the input device pointer (112). The computing system sets the resource icon representing the word processing program as the display icon (116) rendered in the predefined region (114).

In the example of FIG. 4B, the input device pointer (112) is located in the upper middle portion of the predefined region (114). In the example of FIG. 4B, a computing system identifies that a computing resource implemented as a web browser is associated with the portion of the predefined region (114) that matches the location of the input device pointer (112). The computing system may sets the resource icon representing the web browser as the display icon (116) rendered in the predefined region (114).

In the example of FIG. 4C, the input device pointer (112) is located in the upper right portion of the predefined region (114). In the example of FIG. 4C, a computing system identifies that a computing resource implemented as a spreadsheet program is associated with the portion of the predefined region (114) that matches the location of the input device pointer (112). The computing system sets the resource icon representing the spreadsheet as the display icon (116) rendered in the predefined region (114).

In the example of FIG. 4D, the input device pointer (112) is located in the lower right portion of the predefined region (114). In the example of FIG. 4D, a computing system identifies that a computing resource implemented as a movie is associated with the portion of the predefined region (114) that matches the location of the input device pointer (112). The computing system sets the resource icon representing the movie as the display icon (116) rendered in the predefined region (114).

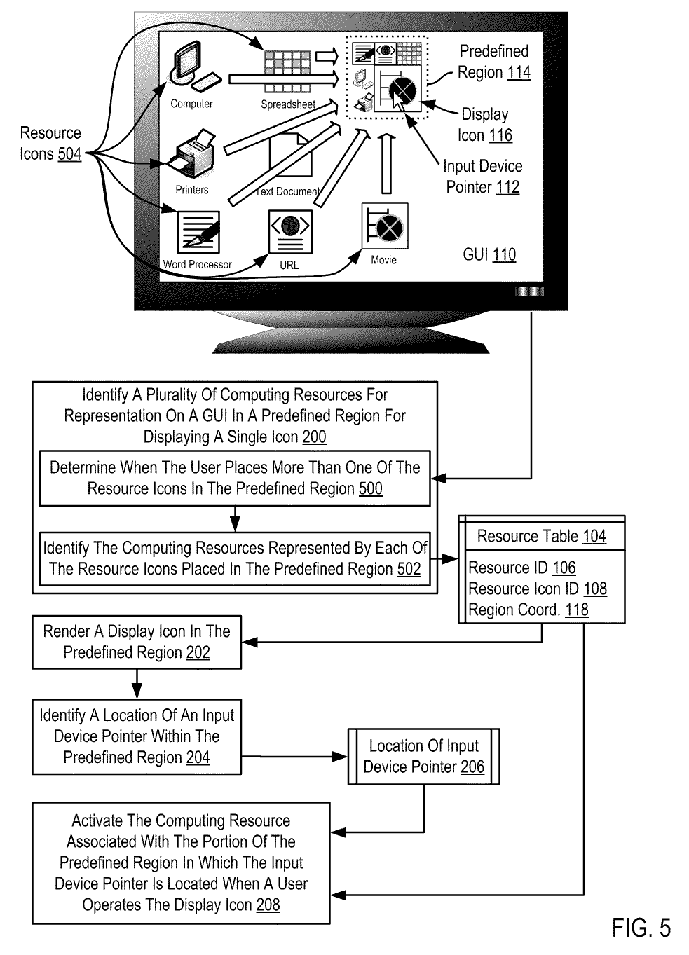

As described above, a predefine region on a GUI for displaying a single icon is used in embodiments of the present invention to provide a user with access to multiple computing resources—as opposed to providing a user with access to a single computing resource. For further explanation regarding the manner in which computing resources may be assigned to a particular predefined region on a GUI, consider FIG. 5 that sets forth a flow chart illustrating a further exemplary method for representing multiple computing resources within a predefined region of a graphical user interface (‘GUI’) for displaying a single icon according to embodiments of the present invention.

The method of FIG. 5 is similar to the method of FIG. 2. That is, the method of FIG. 5 includes: identifying (200) a plurality of computing resources for representation on a GUI in a predefined region (114) for displaying a single icon, each computing resource associated with a portion of the predefined region (114); rendering (202) a display icon (116) in the predefined region (114); identifying (204) a location of an input device pointer (112) within the predefined region (114); and activating (208) the computing resource associated with the portion of the predefined region (114) in which the input device pointer (112) is located when a user operates the display icon (116).

In the method of FIG. 5, identifying (200) a plurality of computing resources for representation on a GUI in a predefined region (114) for displaying a single icon includes: determining (500) when the user places more than one of the resource icons (504) in the predefined region (114), and identifying (502), in response to determining that the user places more than one of the resource icons in the predefined region (114), the computing resources represented by each of the resource icons placed in the predefined region (114). Determining (500) when the user places more than one of the resource icons (504) in the predefined region (114) according to the method of FIG. 5 may be carried out by detecting that a user has dragged and dropped more than one resource icon in the predefined region (114). Detecting that a user has dragged and dropped more than one resource icon in the predefined region (114) may be carried out using GUI notification messages provided by the GUI subsystem in the operating system.

Identifying (502), in response to determining that the user places more than one of the resource icons in the predefined region (114), the computing resources represented by each of the resource icons placed in the predefined region (114) according to the method of FIG. 5 may be carried out by retrieving a resource identifier from the metadata associated with each resource icon placed in the predefined region (114) and storing each resource identifier in a resource table (104) in association with an identifier for the corresponding resource icon and a set of coordinates that specifies a portion of the predefined region (114) assigned to that resource identifier. In the example of FIG. 5, each record in the resource table (104) includes a resource identifier field (106), a resource icon identifier field (108), and a region coordinates field (118). The resource identifier field (106) specifies a particular computing resource (100). The resource icon identifier field (108) specifies an icon or graphic that may be issued to represent the associated computing resource. The region coordinates field (118) specifies the portion of the predefined region (114) that is assigned to the associated computing resource.

The portion of the predefined region (114) that is associated with each computing resource in the resource table (104) may be selected based on user-defined position preferences established by the user through a wizard, a pop-up menu, or some other manner as will occur to those of skill in the art. For example, when the user drags the ‘Spreadsheet’ icon illustrated in FIG. 5 into the predefined region (114), a dialogue box may ask the user to specify which portion of the predefined region (114) should be associated with the spreadsheet program. In the example of FIG. 5, the upper right portion of the predefined region (114) is associated with the spreadsheet program using the resource table (104).

In addition to user-defined position preferences, the portion of the predefined region (114) that is associated with each computing resource in the resource table (104) may also be selected based on historical usage statistics for that computing resource. For example, consider FIG. 5 in which users have historically clicked on the ‘Movie’ icon more than the other resource icons (504) on the GUI (110). In such an example, the movie computing resource is provided a larger portion of the predefined region (114) than the other computing resources accessible through the predefined region (114). Even after all of the portions of the predefined region (114) have been allocated to the computing resources, as the user accesses the various resources through the predefined region (114), the portions of the predefined region (114) associated with each computing resource may be altered as more historical usage statistics are obtained. For example, if a user begins utilizing a spreadsheet program through the predefined region (114) illustrated in FIG. 5 more regularly than the other computing resources, a larger portion of the predefined region (114) may be assigned to the spreadsheet program. Accordingly, the graphic used to represent the spreadsheet program in the display icon (116) would get larger and one or more of the other graphics used in the display icon (116) would become smaller.

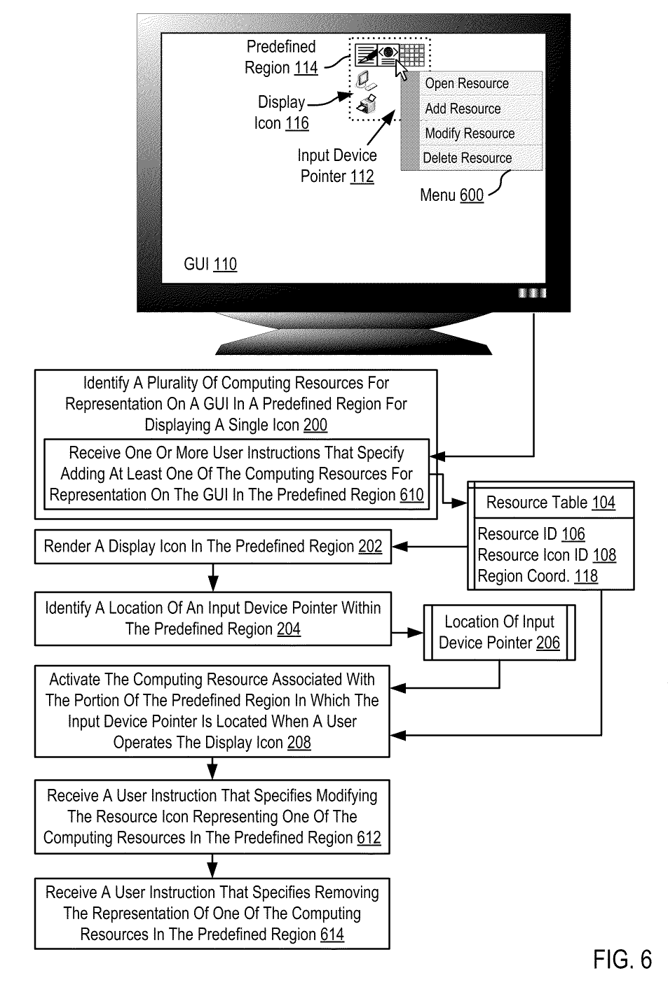

The description above with reference to FIG. 5 explains that a computing system may identify a plurality of computing resources for representation in a predefined region of a GUI as the user places more than one resource icon in the predefined region. In other embodiments, however, a computing system may identify a plurality of computing resources for representation in a predefined region of a GUI by receiving one or more user instructions that specify adding at least one of the computing resources for representation on the GUI in the predefined region. For further explanation, consider FIG. 6 that sets forth a flow chart illustrating a further exemplary method for representing multiple computing resources within a predefined region of a graphical user interface (‘GUI’) for displaying a single icon according to embodiments of the present invention.

The method of FIG. 6 is similar to the method of FIG. 2. That is, the method of FIG. 6 includes: identifying (200) a plurality of computing resources for representation on a GUI in a predefined region (114) for displaying a single icon, each computing resource associated with a portion of the predefined region (114); rendering (202) a display icon (116) in the predefined region (114); identifying (204) a location of an input device pointer (112) within the predefined region (114); and activating (208) the computing resource associated with the portion of the predefined region (114) in which the input device pointer (112) is located when a user operates the display icon (116).

In the method of FIG. 6, identifying (200) a plurality of computing resources for representation on a GUI in a predefined region (114) for displaying a single icon includes receiving (610) a user instruction that specifies adding at least one of the computing resources for representation on the GUI (110) in the predefined region (114). Receiving (610) a user instruction that specifies adding at least one of the computing resources for representation on the GUI (110) in the predefined region (114) according to the method of FIG. 6 may be carried out by receiving a user selection from a pop-up menu (600) and providing, in response to receiving the user selection, the user with a dialogue box to input the computing resources for representation in the predefined region (114). For example, a user may select the menu item ‘Add Resource’ from the menu (600) to add a computing resource for representation in the predefined region (114) on the GUI (110).

The method of FIG. 6 also includes receiving (612) one or more user instructions that specify modifying the resource icon representing one of the computing resources in the predefined region (114). Receiving (612) one or more user instructions that specify modifying the resource icon representing one of the computing resources in the predefined region (114) according to the method of FIG. 6 may be carried out by receiving a user selection from a pop-up menu (600) and providing, in response to receiving the user selection, the user with a dialogue box to modify the resource icon representing one of the computing resources in the predefined region (114). For example, a user may select the menu item ‘Modify Resource’ from the menu (600) to modify the resource icon representing one of the computing resources in the predefined region (114) on the GUI (110).

The method of FIG. 6 includes receiving (614) one or more user instructions that specify removing the representation of one of the computing resources in the predefined region (114). Receiving (614) one or more user instructions that specify removing the representation of one of the computing resources in the predefined region (114) according to the method of FIG. 6 may be carried out by receiving a user selection from a pop-up menu (600) and providing, in response to receiving the user selection, the user with a dialogue box to remove the representation of one of the computing resources in the predefined region (114). For example, a user may select the menu item ‘Delete Resource’ from the menu (600) to remove the representation of one of the computing resources in the predefined region (114) on the GUI (110).

Exemplary embodiments of the present invention are described largely in the context of a fully functional computer system for representing multiple computing resources within a predefined region of a graphical user interface (‘GUI’) for displaying a single icon. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method of representing multiple computing resources within a predefined region of graphical user interface (‘GUI’) for displaying a single icon, the method comprising:
identifying a plurality of computing resources for representation on the GUI in a predefined region for displaying a single icon, each computing resource associated with a portion of the predefined region;
rendering a display icon in the predefined region;
identifying a location of an input device pointer within the predefined region; and
activating the computing resource associated with the portion of the predefined region in which the input device pointer is located when a user operates the display icon.

2. The method of claim 1 wherein each computing resource is represented by an resource icon and the method further comprises:
identifying the computing resource associated with the portion of the predefined region that matches the location of the input device pointer; and
setting the resource icon representing the identified computing resource as the display icon rendered in the predefined region.

3. The method of claim 1 wherein:
each computing resource is represented by an resource icon on the GUI; and
identifying a plurality of computing resources for representation on a GUI in a predefined region for displaying a single icon further comprises:
determining when the user places more than one of the resource icons in the predefined region, and
identifying, in response to determining that the user places more than one of the resource icons in the predefined region, the computing resources represented by each of the resource icons placed in the predefined region.

4. The method of claim 1 wherein identifying a plurality of computing resources for representation on a GUI in a predefined region for displaying a single icon further comprises receiving one or more user instructions that specify adding at least one of the computing resources for representation on the GUI in the predefined region.

5. The method of claim 1 further comprising receiving one or more user instructions that specify modifying the resource icon representing one of the computing resources in the predefined region.

6. The method of claim 1 further comprising receiving one or more user instructions that specify removing the representation of one of the computing resources in the predefined region.

7. The method of claim 1 wherein each computing resource is associated with a portion of a predefined region according to user-defined position preferences.

8. The method of claim 1 wherein each computing resource is associated with a portion of a predefined region according to historical usage statistics for that computing resource.

9. Apparatus for representing multiple computing resources within a predefined region of a graphical user interface (‘GUI’) for displaying a single icon, the apparatus comprising a computer processor, a computer memory operatively coupled to the computer processor, the computer memory having disposed within it computer program instructions capable of:
identifying a plurality of computing resources for representation on the GUI in a predefined region for displaying a single icon, each computing resource associated with a portion of the predefined region;
rendering a display icon in the predefined region;
identifying a location of an input device pointer within the predefined region; and
activating the computing resource associated with the portion of the predefined region in which the input device pointer is located when a user operates the display icon.

10. The apparatus of claim 9 wherein each computing resource is represented by an resource icon and the computer memory has disposed within it computer program instructions capable of:
identifying the computing resource associated with the portion of the predefined region that matches the location of the input device pointer; and
setting the resource icon representing the identified computing resource as the display icon rendered in the predefined region.

11. The apparatus of claim 9 wherein:
each computing resource is represented by an resource icon on the GUI; and
identifying a plurality of computing resources for representation on a GUI in a predefined region for displaying a single icon further comprises:
determining when the user places more than one of the resource icons in the predefined region, and
identifying, in response to determining that the user places more than one of the resource icons in the predefined region, the computing resources represented by each of the resource icons placed in the predefined region.

12. A computer program product for representing multiple computing resources within a predefined region of a graphical user interface (‘GUI’) for displaying a single icon, the computer program product disposed in a signal bearing medium, the computer program product comprising computer program instructions capable of:
identifying a plurality of computing resources for representation on the GUI in a predefined region for displaying a single icon, each computing resource associated with a portion of the predefined region;
rendering a display icon in the predefined region;
identifying a location of an input device pointer within the predefined region; and
activating the computing resource associated with the portion of the predefined region in which the input device pointer is located when a user operates the display icon.

13. The computer program product of claim 12 wherein each computing resource is represented by an resource icon and the method further comprises:
identifying the computing resource associated with the portion of the predefined region that matches the location of the input device pointer; and
setting the resource icon representing the identified computing resource as the display icon rendered in the predefined region.

14. The computer program product of claim 12 wherein:
each computing resource is represented by an resource icon on the GUI; and
identifying a plurality of computing resources for representation on a GUI in a predefined region for displaying a single icon further comprises:
determining when the user places more than one of the resource icons in the predefined region, and
identifying, in response to determining that the user places more than one of the resource icons in the predefined region, the computing resources represented by each of the resource icons placed in the predefined region.

15. The computer program product of claim 12 further comprising computer program instructions capable of receiving one or more user instructions that specify modifying the resource icon representing one of the computing resources in the predefined region.

16. The computer program product of claim 12 further comprising computer program instructions capable of receiving one or more user instructions that specify removing the representation of one of the computing resources in the predefined region.

17. The computer program product of claim 12 wherein each computing resource is associated with a portion of a predefined region according to user-defined position preferences.

18. The computer program product of claim 12 wherein each computing resource is associated with a portion of a predefined region according to historical usage statistics for that computing resource.

19. The computer program product of claim 12 wherein the computer readable medium comprises a recordable medium.

20. The computer program product of claim 12 wherein the computer readable medium comprises a transmission medium.
